(19) United States
(12) Patent Application Publication
(10) Pub. No.: US 2024/0051047 A1
(43) Pub. Date: Feb. 15, 2024

(54) TOOL HEAD COMPRISING BALANCING DEVICES AND A CLAMPING ELEMENT, AND MACHINE TOOL COMPRISING SUCH A TOOL HEAD

(71) Applicant: REISHAUER AG, Wallisellen (CH)

(72) Inventors: Adrian Marcel HALTER, Wallisellen (CH); Theophil HUG, Wallenwil (CH); Michel MÜLLER, Uster (CH)

(73) Assignee: REISHAUER AG, Wallisellen (CH)

(21) Appl. No.: 18/268,195

(22) PCT Filed: Dec. 7, 2021
(86) PCT No.: PCT/EP2021/084605

§ 371 Date: Jun. 16, 2023

(30) Foreign Application Priority Data
Dec. 18, 2020 (CH) 1623/20

(51) Int. Cl. B23F 23/10; B23F 23/12; B24B 41/04; B24B 41/06

(52) U.S. Cl. CPC B23F 23/10; B23F 23/1206; B23F 23/1237; B24B 41/042; B24B 41/062

(57) ABSTRACT

A tool head for a gear cutting machine includes a first spindle unit having a first spindle shaft and a second spindle unit having a second spindle shaft. A tool is axially receivable between the first spindle shaft and the second spindle shaft. A balancing device is associated with each spindle unit. The balancing device radially surrounds the respective spindle shaft and is axially arranged between a tool-side spindle bearing of the corresponding spindle unit and the tool-side end of the corresponding spindle shaft. The tool is axially clamped between the two spindle shafts by a pull rod and a clamping element.

### TECHNICAL FIELD

The present invention relates to a tool head. The present invention further relates to a machine tool having such a tool head.

### PRIOR ART

Rotating tools are used in many machine tools. In order to achieve high-quality machining results, it is necessary to balance the tools, i.e. to eliminate unbalances. This applies in particular to gear cutting machines, i.e. machines for machining gears.

Unbalance is the term used for the situation when the axis of rotation of a rotating body does not correspond to one of its principal axes of inertia. A distinction is made between static and dynamic unbalance. In most cases, both forms occur simultaneously. Static unbalance occurs when the axis of rotation does not pass through the center of gravity of the rotating body. Static unbalance creates a circular motion of the body's center of gravity when the body rotates. Dynamic unbalance occurs when the axis of rotation at the center of gravity is tilted with respect to the principal axes of inertia. Dynamic unbalances cause circular vibrations shifted by 180° at the ends of the axis. The center of gravity of the rotating body remains at rest, while the axis wobbles because of the opposing circular motions. If the axis is fixed by bearings, a corresponding load on the bearings occurs.

Unbalances on the tool lead to reduced manufacturing accuracy during workpiece machining, to poorer surface quality and to faster wear of the tool. In addition, bearing damage can occur. The aim of balancing is to limit tool vibrations and bearing forces to acceptable values.

Special challenges arise when tools with small diameters are to be balanced. In particular, tools with small diameters are increasingly being used in gear manufacturing. In order to achieve the desired cutting speed, such tools are usually operated at relatively high rotational speeds. Since the unbalance forces increase proportional to the square of the rotational speed, very high unbalance forces can occur. At the same time, such tools are often relatively long in relation to their diameter. As a result, bending moments caused by dynamic unbalance have a particularly strong effect.

It is known from the prior art to minimize unbalances on rotating tools by suitable balancing devices. Balancing devices are often arranged inside the tool, as shown in FIG. 1 of EP3153277A1. However, such an arrangement has limitations when small diameter tools are to be used. The available space inside the tool is then often no longer sufficient to install a sufficiently performant balancing device.

To solve this problem, EP3153277A1 proposes to accommodate the tool between a motor spindle and a drive-free counter spindle and to integrate the balancing devices in the shafts of the motor spindle and the counter spindle. A disadvantage of this solution is that the balancing devices are relatively far away from the tool and from the bearing locations of the motor spindle and the counter spindle which are close to the tool. Also, there is often not enough space available in the shafts of the motor spindle and the counter spindle for the installation of a performant balancing system.

### SUMMARY OF THE INVENTION

It is an object of the present invention to provide a tool head which can be used for small diameter tools and which permits efficient balancing of such tools.

This object is solved by a tool head according to claim 1. Further embodiments are given in the dependent claims.

Thus, a tool head for a machine tool, in particular for a gear cutting machine, is disclosed. The tool head has:
a first spindle unit with a first spindle shaft which is mounted in the first spindle unit so as to be rotatable about a tool spindle axis;
a first balancing device associated with the first spindle unit;
a second spindle unit with a second spindle shaft which is mounted in the second spindle unit so as to be rotatable about the tool spindle axis;
a second balancing device associated with the second spindle unit.

The first spindle unit and the second spindle unit are arranged coaxially with respect to each other such that a tool is receivable axially between the first spindle shaft and the second spindle shaft. According to the invention, the first balancing device surrounds the first spindle shaft radially and is arranged axially between a tool-side spindle bearing of the first spindle unit and a tool-side end of the first spindle shaft, and/or the second balancing device surrounds the second spindle shaft radially and is arranged axially between a tool-side spindle bearing of the second spindle unit and a tool-side end of the second spindle shaft.

Thus, when a tool is received between the first spindle shaft and the second spindle shaft, the first and/or second balancing device is arranged outside the respective spindle shaft and axially between a tool-side spindle bearing of the associated spindle unit and the tool. The proposed arrangement makes it possible to also efficiently balance tools with small diameters. By arranging at least one of the balancing devices, preferably both balancing devices, around the spindle shafts, considerably more space is available for the balancing elements than if both balancing devices are arranged inside the tool or inside the spindle shafts. As a result, even relatively large unbalances can be corrected. By arranging the corresponding balancing device axially between a tool-side spindle bearing and the tool, balancing with this balancing device takes place both close to the tool and close to the corresponding bearing locations. This enables very precise balancing.

The respective spindle unit will often comprise more than one single spindle bearing. The term “tool-side spindle bearing” is then to be understood as relating to that spindle bearing which is arranged closest to the tool within the respective spindle unit along the tool spindle axis.

In particular, the arrangement of the balancing planes relative to the bearing planes of the two spindle units may be as follows: the tool-side first spindle bearing defines a first bearing plane perpendicular to the tool spindle axis, and the tool-side second spindle bearing defines a second bearing plane perpendicular to the tool spindle axis. The first balancing device defines a first balancing plane perpendicular to the tool spindle axis, and the second balancing device defines a second balancing plane perpendicular to the tool spindle axis. It is then preferred if the first balancing plane is arranged between the first bearing plane and the second balancing plane (in particular closer to the first bearing plane than to the second balancing plane) and/or the second balancing plane is arranged between the second bearing plane and the first balancing plane (in particular closer to the second bearing plane than to the first balancing plane).

When a tool is received between the two spindle shafts, the tool defines a center of gravity plane perpendicular to the tool spindle axis which contains the center of gravity of the tool. The first balancing plane then preferably lies between the first bearing plane and the center of gravity plane, and/or the second balancing plane preferably lies between the second bearing plane and the center of gravity plane. It is preferred if the respective balancing plane is closer to the corresponding bearing plane than to the center of gravity plane.

This arrangement of balancing planes enables efficient two-plane balancing.

In preferred embodiments, the first balancing device and/or the second balancing device is configured as a ring balancing system. Ring balancing systems have been known in the prior art for a long time (see, for example, DE4337001A1, U.S. Pat. No. 5,757,662A) and enable very precise automatic balancing without the need to stop the rotation of the spindles. They are available on the market in various embodiments. However, another type of balancing system can also be used instead, for example a balancing system with balancing weights that can be moved by an electric motor or a hydraulic balancing system.

The balancing devices may be configured to operate in a numerically controlled (NC) manner. For this purpose, the first and/or second balancing device may comprise at least one actuator for numerically controlled adjustment of a correction unbalance of the balancing device concerned.

At least one vibration sensor may be provided on the tool head for detecting vibrations caused by an unbalance. This sensor may be integrated into one of the balancing devices or may be configured separately. The tool head may further have associated therewith a control device configured to detect signals from the at least one vibration sensor and to control the actuators in the first and/or second balancing device to adjust correction unbalances in the first and/or second balancing device depending to the detected signals. This adjustment may be automated such that the unbalance is reduced. Preferably, the control device is configured to perform an automatic two-plane balancing. Corresponding algorithms are well known from the prior art. The control device may be part of a machine control system or may be a separate unit.

Preferably, the first and/or second balancing device is arranged outside the housing of the respective spindle unit. In particular, the first spindle unit may comprise a first housing and the second spindle unit may comprise a second housing. The first and/or second balancing device is then preferably arranged outside the first and second housings. Alternatively, the first and second spindle units may comprise a common spindle housing, and the first and/or second balancing device is then preferably arranged outside the common spindle housing.

In particular, the first balancing device is preferably arranged axially between the (first or common) spindle housing, which encloses the first spindle unit, and the tool, and the second balancing device is arranged axially between the (second or common) spindle housing, which encloses the second spindle unit, and the tool when the tool is received between the first spindle shaft and the second spindle shaft.

Preferably, the outer contours of the balancing devices are optimized such that the interference contour is minimized when machining workpieces on a workpiece spindle of the machine. Specifically, it is advantageous if the first and/or second balancing device has an outer contour which tapers in the direction of the tool.

A considerably improved balancing result can be achieved if the two spindle shafts are axially clamped to the tool so that an axial compression force acts on the tool on both sides. For this purpose, the following design is particularly advantageous: the second spindle shaft has at least one axial bore. The tool head correspondingly comprises at least one pull rod (drawbar) extending through the corresponding axial bore of the second spindle shaft, the pull rod being connectable at a first end to the first spindle shaft. The pull rod is connectable at its second end to the second spindle shaft such that an axial compression force can be generated on the tool between the first spindle shaft and the second spindle shaft. For this purpose, the tool correspondingly also has at least one axial bore, so that the respective pull rod can be passed through the corresponding bore of the tool.

This type of axial bracing creates a unit of the two spindle shafts and the tool, which is particularly resistant to torsion and bending. The combination of pull rod and clamping element enables a high axial compression force between the tool and the two spindle shafts. As a result, the aforementioned unit acts as a single shaft. At the same time, this construction can be very compact. This makes this construction particularly suitable for tools with a small diameter.

Said construction is also advantageous when there are no balancing devices or when the balancing devices are configured differently than described above. In this respect, the present invention also relates to a tool head for a machine tool, in particular for a gear cutting machine, comprising:
a first spindle unit having a first spindle shaft which mounted in the first spindle unit so as to be rotatable about a tool spindle axis; and
a second spindle unit with a second spindle shaft which is mounted in the second spindle unit so as to be rotatable about the tool spindle axis,
wherein the first spindle unit and the second spindle unit are arranged such that a tool is axially receivable between the first spindle shaft and the second spindle shaft to drive the tool to rotate about the tool spindle axis,
wherein the second spindle shaft has at least one axial bore,
wherein the tool head comprises at least one pull rod extending through the axial bore of the second spindle shaft,
wherein the pull rod is connectable at a first end to the first spindle shaft, and
wherein the pull rod is connectable at its other end to the second spindle shaft in such a way that an axial compression force can be generated on the tool between the first spindle shaft and the second spindle shaft.

In this context, it is advantageous if the first spindle unit comprises at least one first spindle bearing, the first spindle shaft being mounted in the first spindle bearing so as to be rotatable about the tool spindle axis, and the first spindle bearing being configured to absorb both radial and axial forces, and if the second spindle unit correspondingly comprises a second spindle bearing, wherein the second spindle shaft is mounted in the second spindle bearing so as to be rotatable about the tool spindle axis, and wherein the second spindle bearing is configured to absorb both radial and axial forces.

Preferably, there is exactly one pull rod which extends through a central axial bore in the second spindle shaft. Accordingly, it is preferred that the tool also has a central axial bore through which the pull rod can be passed.

In a particularly simple embodiment, the pull rod is connectable to the first spindle shaft by screwing it axially into the first spindle shaft. For this purpose, complementary threads (internal and external threads) can be formed on the corresponding end of the pull rod and on the first spindle shaft. However, other types of connection are also conceivable, for example a bayonet-type connection. The pull rod may also extend through an axial bore of the first spindle shaft and be provided at its end with, for example, a nut which pulls the first spindle shaft in direction of the tool.

The pull rod may advantageously be provided at its other, free end with a clamping element forming an annular contact surface, the annular contact surface bearing against the second spindle shaft after the pull rod has been connected to the first spindle shaft and generating an axial compression force on the second spindle shaft in order to push it in the direction of the first spindle shaft. In the simplest case, the pull rod may be formed for this purpose, for example, as a screw having a screw head. The screw may then be screwable into the first spindle shaft, and the screw head may form the clamping element. The axial clamping force is then generated simply by tightening the screw.

In another, also very simple embodiment, the pull rod is provided at its free end with an external thread onto which a nut can be screwed. In this case, the nut forms the clamping element and the axial compression force is generated quite simply by tightening the nut.

Preferably, however, the tool head comprises a clamping element that is releasably connectable to the pull rod and generates a compression force that preferably acts purely axially, without a tightening of the clamping element generating a torque component about the tool spindle axis. For this purpose, the clamping element comprises a base element which is rigidly connectable to the pull rod, for example via a screw connection, via a bayonet or via a clamping bush. The base element may have a central receiving opening to receive the pull rod, or (if sufficient space is available) a pin fixable in an axial bore of the pull rod. The clamping element further comprises an axial push element which is axially movable, in particular axially displaceable, relative to the base element in the direction of the second spindle shaft in order to push the second spindle shaft axially in the direction of the first spindle shaft. The axial push element may in particular be annular and surround the central receiving opening or the pin of the base element, in which case the axial push element may also be referred to as a “push ring”. The axial push element forms the annular contact surface already mentioned. The clamping element further comprises at least one actuating element, the actuating element being movable relative to the base element to axially move the axial push element relative to the base element. The actuating element may be, for example, a pressure screw which can be screwed into the base element along a longitudinal or transverse direction. Such clamping elements are known per se from the prior art and are commercially available in many variants.

In some embodiments, the transmission of force from the actuating element to the axial push element is purely mechanical. For example, the actuating elements may be a plurality of cap screws axially retained on the base element and screwable into the axial push element to axially displace the axial push element relative to the base element. In other embodiments, one or more set screws, which are adjustable in the base element in the direction of the axial push element via a threaded connection, serve as actuating elements. In still other embodiments, the actuating element acts, for example, on a gear that advances the axial push element. Such clamping elements are available, for example, under the designations ESB, ESG or ESD from Enemac GmbH, Kleinwallstadt, Germany.

In other embodiments, the transmission of force from the actuating element to the axial push element is hydraulic. For this purpose, the actuating element may be configured, for example, as a pressure screw which generates a pressure in a hydraulic system when it is screwed in, this pressure acting on the axial push element. Such clamping elements are available, for example, from Albert Schrem Werkzeugfabrik GmbH, Herbrechtingen, Germany.

Instead of generating the axial compression force between the pull rod and the second spindle shaft with a clamping element which remains on the pull rod during operation, it is also conceivable to first generate the compression force with a clamping tool, to fix the connection in the clamped state with a simple nut, and to subsequently remove the clamping tool again.

However, the tool may also be clamped between the first spindle shaft and the second spindle shaft in a way other than with a continuous pull rod, as long as this results in a firmly clamped unit comprising the two spindle shafts and the tool. Thus, embodiments are conceivable in which a first pull rod is connectable to the tool at a first end, for example screwable to the tool or connectable via a hollow shank taper connection. The first pull rod may then extend through an axial bore of the first spindle shaft and may be connectable at its second end to the first spindle shaft in such a way that an axial compression force can be generated between the first spindle shaft and the tool. A second pull rod may be arranged on the opposite side of the tool. This second pull rod may in turn be connectable to the tool at a first end, for example screwable to the tool or connectable via a hollow shank taper connection. The second pull rod may then extend through an axial bore of the second spindle shaft and may be connectable at its second end to the second spindle shaft such that an axial compression force can be generated between the second spindle shaft and the tool.

In order to receive the tool between the spindle shafts and to be able to transmit a torque to the tool, it is advantageous if a spindle nose is formed on the first and/or second spindle shaft in such a way that a non-positive and/or positive connection to the tool can be produced at the respective spindle nose by an axial compression force acting between the tool and the spindle nose. Preferably, the connection to the tool is made via a conical connection, more preferably via a conical connection with face contact. For example, the connection can be made via one of the embodiments A, BF, BM, CF or CM mentioned in DIN ISO 666:2013-12.

It is advantageous if the two spindle noses are configured differently in such a way that the tool can only be received between the spindle noses in a predetermined position. For example, the diameters of the two spindle noses may be different.

In order to facilitate the tool change, it is advantageous if the second spindle unit is axially displaceable relative to the first spindle unit. If both spindle units are accommodated in a common spindle housing, this can be achieved by having the spindle bearings for the second spindle shaft being axially displaceable relative to this spindle housing.

The first and/or second spindle units may include a drive motor configured to drive the corresponding spindle shaft to rotate about the tool spindle axis, thereby driving the tool. In some embodiments, only the first spindle unit comprises a drive motor, and the second spindle unit forms a passive counter spindle for the first spindle unit, without an own drive motor. In other embodiments, the second spindle unit also comprises its own drive motor. The respective drive motor may in particular be a direct-drive.

The tool head may further comprise the aforementioned tool, the tool being axially received between the first spindle shaft and the second spindle shaft and preferably axially clamped. The tool may be a grinding tool, in particular a tool for gear grinding. More specifically, the tool may be a grinding worm or a profile grinding wheel or comprise at least one grinding worm and/or at least one profile grinding wheel. The tool may be in one piece (e.g. in the form of a non-dressable grinding worm with a hard coated base body received directly between the spindle shafts), or it may be in two or more pieces (e.g. in the form of a dressable grinding worm or a combination tool with more than one grinding body, wherein the grinding body or bodies are held on a separate tool holder and the tool holder is received between the spindle shafts).

The present invention further provides a machine tool comprising a tool head of the type mentioned above and at least one workpiece spindle for driving a workpiece to rotate about a workpiece axis. The machine tool may be configured as a gear cutting machine, in particular as a gear grinding machine. For this purpose, the machine tool may comprise a machine control system configured (in particular appropriately programmed) to cause the machine to machine a gear teeth of a workpiece received on the at least one workpiece spindle with the tool. In particular, the machine control system may be configured to cause the machine to machine the gear teeth of the workpiece by profile grinding or generating gear grinding. For this purpose, the machine control system may be configured to establish a suitable rolling coupling between the workpiece spindle and the tool spindle.

### BRIEF DESCRIPTION OF THE DRAWINGS

Preferred embodiments of the invention are described below with reference to the drawings, which are for explanatory purposes only and are not to be construed in a limiting manner.

In the drawings,

FIG. 1 shows an example of a machine tool for hard finishing of gears by generating gear grinding in a schematic perspective view, with a tool head according to a first embodiment;

FIG. 2 shows a schematic perspective view of the tool head of the first embodiment;

FIG. 3 shows the tool head of the first embodiment in a perspective sectional view;

FIG. 4 shows the tool head of the first embodiment in a sectional view looking from the front, against the X-direction;

FIG. 5 shows a schematic block diagram illustrating the control of the balancing devices in the tool head of the first embodiment;

FIG. 6 shows a tool head according to a second embodiment in a perspective sectional view;

FIG. 7 shows a tool head according to a third embodiment in a perspective sectional view, together with a workpiece spindle;

FIG. 8 shows an enlarged view of area D in FIG. 7;

FIG. 9 shows a clamping nut in a central longitudinal section; and

FIG. 10 shows the clamping nut of FIG. 9 in a perspective view.

### DESCRIPTION OF PREFERRED EMBODIMENTS

### Definitions

Gear cutting machine: A machine configured to produce or machine gear teeth on workpieces, in particular internal or external gear teeth of gears. For example, a gear cutting machine can be a machine for fine machining, with which pre-toothed workpieces are machined, in particular a hard finishing machine with which pre-toothed workpieces are machined after hardening. A gear cutting machine comprises a machine control system programmed to control automatic machining of the gear teeth.

Generating machining of gears: A type of gear machining in which a tool rolls on a workpiece, producing a cutting motion. Various gear generating machining processes are known, whereby a distinction is made between processes with a geometrically undefined cutting edge, such as gear grinding or gear honing, and processes with a geometrically defined cutting edge, such as gear hobbing, gear peeling, gear shaving or gear shaping.

Generating gear grinding: The generating gear grinding process is a continuous chip-removing process with a geometrically undefined cutting edge for the production of axially symmetrical periodic structures, in which a grinding wheel with a worm-shaped profiled outer contour (“grinding worm”) is used as the tool. Tool and workpiece are mounted on rotation spindles. By coupling the rotation movements of tool and workpiece around the rotation axes, the rolling motion typical of the process is realized. This rolling motion and an axial feed motion of the tool or the workpiece along the workpiece axis generate a cutting motion.

Spindle unit: In machine tool construction, a rotatable shaft on which a tool or workpiece can be clamped is usually referred to as a “spindle”. However, an assembly which, in addition to the rotatable shaft, also includes the associated spindle bearings for rotatably bearing the shaft and the associated housing is also frequently referred to as a “spindle”. In the present document, the term “spindle” is used in this sense. The shaft alone is referred to as the “spindle shaft”. An assembly comprising, in addition to the spindle shaft, at least the associated spindle bearings is referred to as a “spindle unit”. A “spindle unit” may comprise its own housing, but it may also be accommodated in a common housing together with another spindle unit.

Toolhead: In the present document, the term “tool head” refers to an assembly configured to receive and drive a machining tool for rotation. In particular, the tool head may be mounted on a swivel body and/or one or more slides to align and position the tool relative to a workpiece.

Ring balancing system: A ring balancing system has two adjacently arranged balancing rings which surround a shaft and are driven by it. Each balancing ring has a predetermined additional unbalance of the same size. The orientation of the balancing rings about the axis of rotation of the shaft is adjustable. If the additional unbalances of the two balancing rings are diametrically opposed, their effects cancel each other out. If both additional unbalances have the same angular position, the maximum balancing capacity is achieved. By setting to other angles, the resulting corrective unbalance can be freely adjusted by magnitude and direction within these limits.

Configuration of an Exemplary Machine Tool

FIG. 1 shows an example of a machine tool for hard finishing of gears by generating gear grinding. The machine comprises a machine bed 100 on which a tool carrier 200 is arranged so as to be displaceable along a horizontal infeed direction X. A Z-slide 210 is arranged on the tool carrier 200 so as to be displaceable along a vertical direction Z. The Z-slide 210 carries a swivel body 220, which is pivotable relative to the Z-slide 210 about a horizontal swivel axis A. The swivel axis A is parallel to the infeed direction X. A tool head 300, shown only symbolically, is arranged on the swivel body 220 and will be described in more detail below.

Furthermore, a pivotable workpiece carrier in the form of a rotary turret 400 is arranged on the machine bed 100. The rotary turret 400 is pivotable about a vertical swivel axis C3 between several rotational positions. It carries two workpiece spindles 500, on each of which a workpiece 510 can be clamped. Each of the workpiece spindles 500 is drivable to rotate about a workpiece axis. In FIG. 1, the workpiece axis of the visible workpiece spindle 500 is designated C2. The workpiece axis of the workpiece spindle not visible in FIG. 1 is designated C1 axis. The two workpiece spindles are located on the rotary turret 400 in diametrically opposite positions (i.e., offset by 180° with respect to the swivel axis C3). In this way, one of the two workpiece spindles can be loaded and unloaded while a workpiece is being machined on the other workpiece spindle. This largely avoids undesirable non-productive times. Such a machine concept is known, for example, from WO 00/035621 A1.

The machine has a machine control system 700, shown only symbolically, which includes a plurality of control modules 710 and a control panel 720. Each of the control modules 710 controls a machine axis and/or receives signals from sensors.

Tool Head According to a First Embodiment

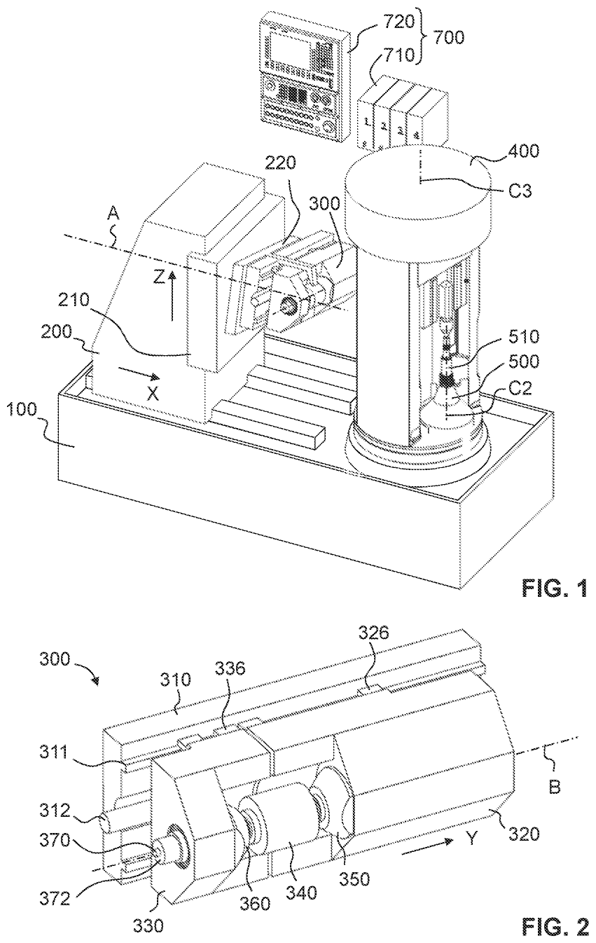

FIGS. 2 to 4 illustrate a tool head according to a first embodiment. The tool head includes a base 310 that is rigidly connected to the swivel body 220. A linear guide 311 is formed on the base 310. A first spindle unit 320 and a second spindle unit 330 are displaceable guided along a shift direction Y on the linear guide 311. For this purpose, the spindle units each have corresponding guide shoes 326, 336. The shift direction Y is perpendicular to the X-axis and at an angle to the Z-axis adjustable about the A-axis. A tool 340 is held between the spindle units 320, 330.

The second spindle unit 320 and the first spindle unit 330 can be coupled to each other after the tool 340 is received between them. When coupled, they can be moved together along the shift direction Y by a shift drive not shown in the drawing and a ball screw drive 312 to change the tool area that is in engagement with a workpiece 510 on the C1 axis along the tool axis.

Configuration of the Spindle Units

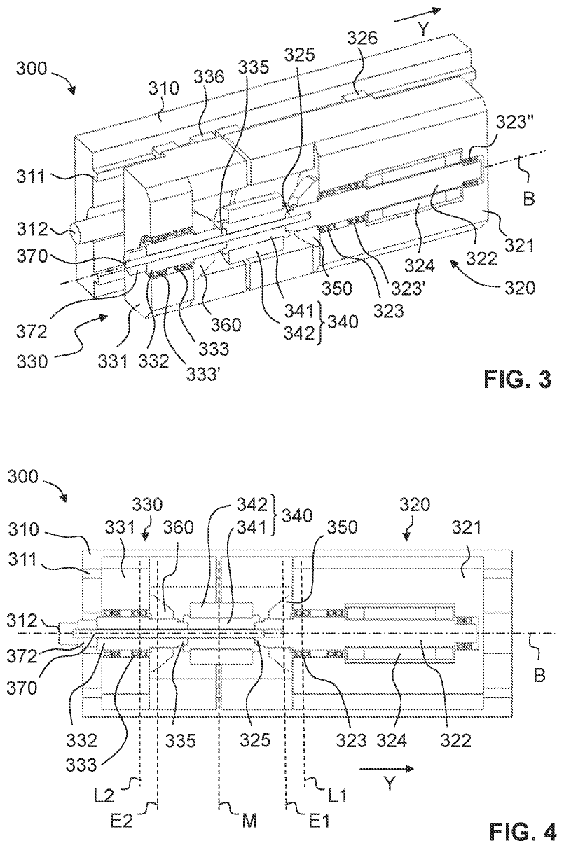

FIGS. 3 and 4 illustrate the configuration of the spindle units 320, 330 in more detail.

In the present example, the spindle unit 320 is a motorized spindle having a drive motor 324 that directly drives a first spindle shaft 322 to rotate about a tool spindle axis B. The tool spindle axis B is parallel to the shift direction Y.

The first spindle shaft 322 is supported in the spindle housing 321 of the first spindle unit 320 at three bearing locations in spindle bearings 323, 323′, 323″. The bearing locations are located at different axial positions along the first spindle shaft 322. Two of these bearing locations are located between the drive motor 324 and the tool-side end of the first spindle unit 320. The corresponding spindle bearings 323, 323′ form a locating-non-locating bearing or a support bearing, i.e. at at least one of these bearing locations the spindle bearings can absorb both radial and axial forces. A further bearing location is located on the side of the drive motor 324 facing away from the tool. The spindle bearing 323″ arranged at this bearing location is configured as a non-locating bearing, i.e. it absorbs radial forces but allows axial movements.

Each of the three bearing locations defines a radial bearing plane. The bearing planes are each orthogonal to the tool spindle axis B. In FIG. 4, the bearing plane for the bearing location closest to the tool end of the first spindle shaft 322 is drawn as the first bearing plane L1. The corresponding spindle bearing closest to the tool end is the spindle bearing 323.

In the present example, the second spindle unit 330 is a non-driven counter spindle. The second spindle unit 330 has a second spindle shaft 332 which is supported in the spindle housing 331 of the second spindle unit 330 at two bearing locations along the spindle shaft in spindle bearings 333, 333′. These spindle bearings may be locating bearings or non-locating bearings, depending on the embodiment. Each of the two bearing locations in turn defines a radial bearing plane. In FIG. 4, the bearing plane for that bearing location which is arranged closest to the tool-side end of the second spindle shaft 332 is drawn as the second bearing plane L2. The corresponding spindle bearing near the tool end is the spindle bearing 333.

Axial Clamping of the Tool

In the present example, the tool 340 has a tool holder 341 which carries a worm-shape profiled dressable abrasive body 342. In the present example, the tool holder 341 is formed as a holding flange for the grinding body according to DIN ISO 666:2013-12. For connection to the spindle shafts 322, 332, the tool holder 341 has a taper receptacle (a.k.a. taper socket or cone seat) with face contact at each end, for example a short taper receptacle 1:4 according to DIN ISO 702-1:2010-04.

Opposing spindle noses 325, 335 are formed at the tool-side ends of the spindle shafts 322, 332. The shape of the spindle noses 324. 325 is complementary to the shape of the taper receptacles of the tool holder 341. They each have a conically tapered shape pointing towards the tool 340 and a plane contact surface on their respective end face. For example, each spindle nose may be formed as a tapered shank 1:4 according to DIN ISO 702-1:2010-04.

Thus, there is a conical connection with a face contact between each of the tool 340 and the spindle shafts 322, 332. The conical connections may have different diameters at the two ends of the tool to ensure that the tool 340 can only be received in the correct orientation between the spindle shafts 322, 332.

The tool 340 is axially clamped between the spindle shafts 332, 332 by a pull rod 370 and a clamping nut 372. To this end, the tool 340 and the second spindle shaft 332 each have a central axial bore extending therethrough. At its tool end, the first spindle shaft 322 also has a central axial bore. This bore is not continuous in the present example. It is open on the tool side, and an internal thread is formed in the bore. The pull rod 370 is inserted through the central bores of the spindle shaft 332 and the tool 340. At its end facing the first spindle unit 320, the pull rod 370 has an external thread which is screwed into the internal thread of the first spindle shaft 322. At its other end, it also has an external thread. The clamping nut 372 is screwed onto this external thread. By tightening the clamping nut 372, the clamping nut 372 exerts an axial pressure on the second spindle shaft 332 in the direction of the tool 340. This causes the tool 340 to be axially clamped between the spindle shafts 332, 332. The result is a single continuous shaft with high rigidity.

Balancing Equipment

A first balancing unit 350 is arranged on the first spindle shaft 322 in the axial region between the housing 321 of the first spindle unit 320 and the tool 340. A second balancing unit 360 is arranged on the second spindle shaft 332 axially between the housing 331 of the second spindle unit 330 and the tool 340. The balancing units 350, 360 surround the respective spindle shafts 322, 332 outside the housing of the respective spindle units 320, 330. They each comprise a housing which tapers from the associated spindle unit towards the tool 340. The tapered outer contour of the balancing units 350, 360 reduces the risk of collision between the balancing units and a workpiece 510.

Each of the balancing units 350, 360 is configured as a ring balancing system. For this purpose, each of the balancing units 350, 360 has a rotor with two balancing rings which surround the respective spindle shaft and are driven by the latter. Each of the balancing units 350, 360 also has a stator. The latter is connected to the respective spindle housing 321, 331. On the one hand, the stator comprises sensors for detecting vibrations of the respective spindle housing, the rotational speed of the respective spindle shaft and the angular position of each balancing ring. On the other hand, the stator includes an actuator with a coil arrangement for changing the angular position of the balancing rings on the respective spindle shaft without contact.

The first balancing unit 350 defines a first balancing plane E1 in which the balancing rings of this balancing unit are arranged. The first balancing plane E1 is orthogonal to the tool spindle axis B. It runs parallel to the first bearing plane L1 and to a radial center of gravity plane of the tool 340. With respect to the tool spindle axis B, the first balancing plane E1 is located between the center of gravity plane M and the first bearing plane L1, outside the first spindle housing 321.

Accordingly, the second balancing unit 360 defines a second balancing plane E2 in which the balancing rings of this balancing unit are arranged. This balancing plane is located between the center of gravity plane M and the second bearing plane L2, outside the second spindle housing 331.

Automatic Balancing in Two Planes

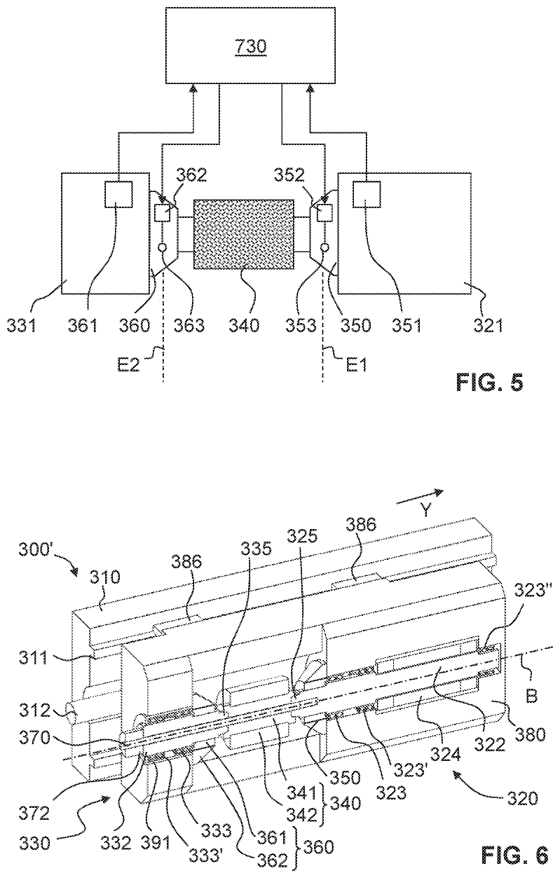

FIG. 5 illustrates in a highly schematic manner a system for automatic balancing in two planes E1, E2. Vibration sensors 351, 361 and actuators 352, 362 of the two balancing units 350, 360 interact with a control device 730. The control device 730 may be integrated into the machine control system 700 or may be configured separately. By means of the control device 730, the angular positions of the balancing rings of both balancing units 350, 360 are automatically calculated and adjusted in such a way that the resulting correction unbalances 353, 363 compensate for the static and dynamic unbalance of the system comprising the tool 340 and the spindle shafts 322, 332 clamped thereto and, accordingly, vibrations of the spindle housings 321, 331 are minimized. In this way, the system is balanced in the two balancing planes E1, E2.

Ring balancing systems with a control device for automatic two-plane balancing are known per se and are commercially available from various suppliers. An example is the AB 9000 electromagnetic ring balancing system from Hofmann Mess-und Auswuchttechnik GmbH & Co KG, Pfungstadt, Germany.

Common Spindle Housing

In FIG. 6, a tool head 300′ according to a second embodiment is illustrated. Components that are the same or act in the same way as in the first and second embodiments are provided with the same reference signs as in FIGS. 2 to 5.

The tool head 300′ of the second embodiment differs from the tool head 300 of the first embodiment in that the two spindle units 320, 330 are accommodated in a common spindle housing 380. The latter is guided by guide shoes 386 on the linear guide 311 along the shift direction Y.

For tool changing, the second spindle unit 330 is retracted axially with respect to the spindle housing 380. For this purpose, the spindle bearings 333 of the second spindle unit are received in a bearing receptacle 391. In the present example, the bearing receptacle 391 is a bearing bushing, which may be, for example, a plain bearing bushing or a ball bearing bushing. The bearing receptacle 391 is guided in the spindle housing 380 so as to be axially displaceable.

The rotor 361 of the second balancing unit 360 is axially displaceable relative to the stator 362 of this balancing unit. The outer diameter of the rotor 361 is smaller than the inner diameter of that portion of the spindle housing 380 in which the bearing receptacle 391 is guided. When the second spindle unit 330 is axially retracted from the spindle housing 380, it takes the rotor 361 of the second balancing unit 360 with it in the axial direction, so that it is retracted into the spindle housing 380 together with the second spindle unit 330. In contrast, the stator 362 of the second balancing unit 360 is fixed to the spindle housing 380 and remains immobile during the retraction of the second spindle unit 330.

Alternatively, it is also conceivable to arrange the second balancing unit 360 in such a way that the entire second balancing unit 360, i.e. both the rotor 361 and the stator 362, can be retracted together with the second spindle unit 330 in order to change the tool.

Two-Sided Drive

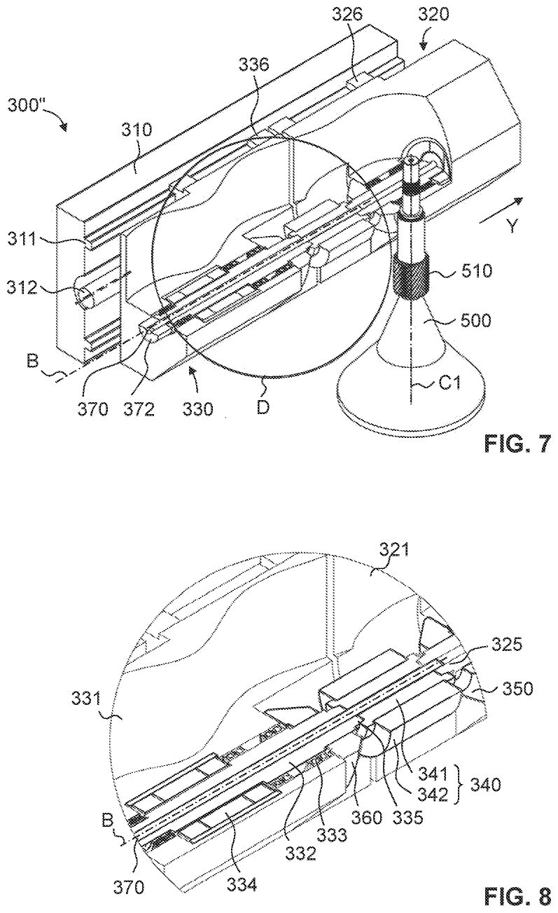

FIGS. 7 and 8 illustrate a tool head 300″ according to a third embodiment. Components that are the same or have the same effect as in the first and second embodiments are provided with the same reference signs as in FIGS. 2 to 6.

The tool head 300″ of the third embodiment differs from the tool head 300 of the first embodiment in that the second spindle unit 330 is also configured as a motor spindle, with a second drive motor 334. Preferably, the second drive motor 334 is dimensioned smaller than the first drive motor 324, so that it generates less than half of the total torque on the tool 340, for example between 35% and 45% of the total torque. This asymmetrical distribution of torque generation between the two drive motors 324, 334 avoids spurious resonances.

Clamping Nut

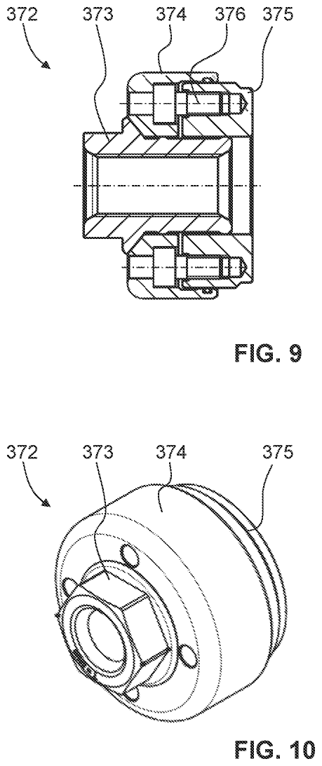

FIGS. 9 and 10 illustrate an exemplary clamping nut 372, such as may be used in the embodiments described above.

The clamping nut 372 includes a base element 373 defining a central bore having an internal thread for screwing the base element 373 onto a pull rod having a corresponding external thread. At one end, the base element 373 is externally formed in the manner of a hex nut. A support ring 374 is mounted on the base element 373. It rests against a collar of the base element 373 in such a way that it is prevented from moving axially in one direction (to the left in FIG. 9). Furthermore, an annular axial push element 375 is axially displaceably guided on the base element 373. A plurality of actuating elements 376 in the form of pressure screws are screwed into the axial push element 375 and are axially supported on the support ring 374 in such a way that they are prevented from moving axially along one direction (to the left in FIG. 9). By unscrewing the pressure screws from the axial push element 375, the axial push element 375 is advanced relative to the base element 373 along the direction opposite to the supporting direction (to the right in FIG. 9).

In order to clamp a tool 340 between the two spindle shafts 322, 332, the axial push element 375 is first moved fully back relative to the base element 373 by screwing the pressure screws as far as possible into the axial push element 375. Now, the clamping nut 372 is screwed onto the pull rod 370 and, with the aid of the externally formed hexagon of the base element 373, is adjusted against the second spindle shaft 332. This is done with a relatively low torque. Subsequently, with the aid of the pressure screws, the annular axial push element 375 is advanced in a controlled manner in the direction of the second spindle shaft 332 until the desired clamping force acts on the tool 340. Thereby, the axial push element 375 bears against the second spindle shaft 332 with an annular contact surface.

Of course, other constructions of a clamping nut can also be used, as known per se from the prior art. For example, the transmission of force may be effected in a different manner than illustrated. In particular, a hydraulic clamping nut may can be used.

Instead of a clamping nut with internal thread, a clamping element may also be used which is connectable to the pull rod in a way other than via a screw connection, e.g. via a bayonet or via a clamping bush.

Other Variations

The interface between the spindle shafts 322, 332 and the tool 340 may also be formed differently than in the embodiments described above. In particular, a different type of conical connection may be used. Any known conical connections may be used, for example the embodiments A, BF, BM, CF or CM mentioned in DIN ISO 666:2013-12. For details, reference is made to DIN ISO 666:2013-12 and to the other standards mentioned therein DIN EN ISO 1119:2012-04, DIN ISO 702-1:2010-04, ISO 12164-1:2001-12 and ISO 12164-2:2001-12.

In any embodiment, the pull rod 370 may extend through the first spindle shaft 322 instead of through the second spindle shaft 332 and may be connected at its end to the second spindle shaft 332. Accordingly, the clamping element then exerts an axial force on the first spindle shaft in the direction of the second spindle shaft.

In order to clamp the tool 340 axially between the first spindle shaft 322 and the second spindle shaft 332, instead of a central pull rod or in addition thereto, two or more pull rods may be used which extend parallel to each other and radially spaced apart from the tool spindle axis B and are arranged at different angular positions relative to the tool spindle axis B.

The fixation of the tool between the first spindle shaft and the second spindle shaft may also be done in another way than with a continuous pull rod, for example with clamping systems arranged inside the respective spindle shaft. For this purpose, the connection between the tool and the spindle shafts may be made, for example, by means of hollow shank taper connections in accordance with ISO 12164-1:2001-12 and ISO 12164-2:2001-12.

The tool may be formed differently than in the embodiments explained above. In particular, the tool may be formed in one piece. For example, the tool may be a non-dressable CBN grinding worm having a CBN coating applied directly to a tool base body. The interfaces to the spindle noses 325, 335 are then formed directly on the tool base body instead of on a separate tool carrier. The tool need not necessarily be a grinding worm. The tool can also be, for example, a profile grinding wheel, a combination of two or more profile grinding wheels or a combination of one or more grinding worms and one or more profile grinding wheels.

In the embodiments described above, the spindle bearings 323 are rolling bearings. Instead, other types of spindle bearings may be used, such as hydrostatic, hydrodynamic or aerodynamic bearings, as is known per se in the prior art.

In the embodiments described above, direct-drives are used as drive motors. Instead, it is also conceivable to use geared motors.

While ring balancing systems are preferably used as balancing devices, other types of balancing devices are also conceivable, e.g. hydro-balancing systems as known per se from the prior art. In such balancing systems, balancing is performed by injecting a fluid into balancing chambers which are distributed in the circumferential direction.

### LIST OF REFERENCE SIGNS

100 machine bed
200 tool carrier
210 Z-slide
220 swivel body
300, 300′, 300″ tool head
310 base
311 linear guide
312 ball screw drive
320 first spindle unit
321 first spindle housing
322 first spindle shaft
323, 323′, 323″ first spindle bearings
324 first drive motor
325 first spindle nose
326 guide shoe
330 second spindle unit
321 second spindle housing
332 second spindle shaft
333, 333′ second spindle bearing
334 second drive motor
335 second spindle nose
336 guide shoe
340 tool
341 tool holder
342 abrasive body
350 first balancing device
351 vibration sensor
352 actuator
360 second balancing device
361 vibration sensor
362 actuator
370 pull rod (drawbar)
372 clamping nut
373 base element
374 support ring
375 axial push element
376 actuating element
380 common spindle housing
386 guide shoe
387 bearing receptacle
400 rotary turret
500 workpiece spindle
510 workpiece
700 machine control system
710 control module
720 control panel
730 control device
X, Y, Z linear axis
A swivel axis
B tool axis
C1, C2 workpiece axis
C3 tower swivel axis
E1, E2 balancing plane
L1, L2 bearing plane

1. A tool head for a machine tool, comprising:
a first spindle unit with a first spindle shaft which is mounted in the first spindle unit so as to be rotatable about a tool spindle axis;
a first balancing device associated with the first spindle unit;
a second spindle unit with a second spindle shaft which is mounted in the second spindle unit so as to be rotatable about the tool spindle axis; and
a second balancing device associated with the second spindle unit,
wherein the first spindle unit and the second spindle unit are arranged coaxially with respect to each other in such a way that a tool is receivable axially between the first spindle shaft and the second spindle shaft, and
wherein at least one of the first balancing device and the second balancing device radially surrounds the spindle shaft of its associated spindle unit and is arranged axially between a tool-side spindle bearing of its associated spindle unit and a tool-side end of said spindle shaft.

2. The tool head of claim 1, wherein the tool is clampable between the first spindle shaft and the second spindle shaft such that an axial compression force acts on the tool between the first spindle shaft and the second spindle shaft.

3. The tool head of claim 2,
wherein the second spindle shaft has at least one axial bore,
wherein the tool head comprises at least one pull rod extending through the axial bore of the second spindle shaft, the pull rod being connectable at a first end to the first spindle shaft, and
wherein the pull rod is connectable at a second end to the second spindle shaft such that an axial compression force can be generated on the tool between the first spindle shaft and the second spindle shaft.

4. The tool head of claim 3, wherein the tool head comprises a clamping element connectable to the pull rod at its second end and configured to axially push the second spindle shaft toward the first spindle shaft.

5. The tool head of claim 4, wherein said clamping element comprises:
a base element rigidly connectable to the pull rod;
an axial push element axially movable relative to the base element in the direction of the second spindle shaft to push the second spindle shaft axially towards the first spindle shaft; and
at least one actuating element, the actuating element being movable relative to the base element to axially move the axial pressure member relative to the base element.

6. The tool head of claim 1,
wherein a first spindle nose is formed at the tool-side end of the first spindle shaft in such a way that at least one of a non-positive and a positive connection to the tool can be produced at the first spindle nose by means of an axial compression force and
wherein a second spindle nose is formed at the tool-side end of the second spindle shaft in such a way that at least one of a non-positive and a positive connection to the tool can be produced at the second spindle nose by an axial compression force.

7. The tool head of claim 6,
wherein the first spindle nose and the second spindle nose are formed differently such that the tool can only be received in a predetermined position between the spindle noses.

8. The tool head of claim 1,
wherein the tool-side first spindle bearing defines a first bearing plane perpendicular to the tool spindle axis,
wherein the tool-side second spindle bearing defines a second bearing plane perpendicular to the tool spindle axis,
wherein the first balancing device defines a first balancing plane perpendicular to the tool spindle axis,
the second balancing device defining a second balancing plane perpendicular to the tool spindle axis, and
wherein the first balancing plane is arranged between the first bearing plane and the second balancing plane and/or the second balancing plane is arranged between the second bearing plane and the first balancing plane.

9. The tool head of claim 1, wherein at least one of the first and second balancing devices is configured as a ring balancing system.

10. The tool head of claim 1, wherein at least one of the first and second balancing devices comprises at least one actuator for numerically controlled adjustment of a correction unbalance of the respective balancing device.

11. The tool head of claim 1,
comprising at least one vibration sensor for detecting vibrations caused by an unbalance in the tool head,
wherein the tool head has associated therewith a control device which is configured to detect signals from the at least one vibration sensor and to control actuators in the first and second balancing devices in order to adjust the first and second balancing devices depending on the detected signals such that the unbalance is reduced.

12. The tool head of claim 1,
wherein the first spindle unit comprises a first housing and the second spindle unit comprises a second housing, and wherein at least one of the first and second balancing devices is arranged outside the first and second housings, or
wherein the first and second spindle units comprise a common spindle housing, and wherein at least one of the first and second balancing devices is arranged outside the common spindle housing.

13. The tool head of claim 12, wherein at least one of the first and the second balancing device has an outer contour that tapers towards the tool.

14. The tool head of claim 1,
wherein at least one of the first spindle unit and the second spindle unit comprises a drive motor configured to drive its respective spindle shaft to rotate about the tool spindle axis.

15. The tool head of claim 1, further comprising a tool, which is axially clamped between the first spindle shaft and the second spindle shaft such that an axial compression force acts on the tool between the first spindle shaft and the second spindle shaft.

16. A tool head for a machine tool, comprising:
a first spindle unit having a first spindle shaft mounted in the first spindle unit so as to be rotatable about a tool spindle axis; and
a second spindle unit with a second spindle shaft which is mounted in the second spindle unit so as to be rotatable about the tool spindle axis,
wherein the first spindle unit and the second spindle unit are arranged such that a tool is axially receivable between the first spindle shaft and the second spindle shaft,
wherein
the second spindle shaft has at least one axial bore,
wherein the tool head comprises at least one pull rod extending through the axial bore of the second spindle shaft, the pull rod being connectable at a first end to the first spindle shaft, and
wherein the pull rod can be connected at a second end to the second spindle shaft in such a way that an axial compression force can be generated on the tool between the first spindle shaft and the second spindle shaft.

17. The tool head of claim 16, wherein the tool head comprises a clamping element connectable to the pull rod at its second end and configured to axially push the second spindle shaft towards the first spindle shaft, and wherein the clamping element comprises:
a base element rigidly connectable to the pull rod;
an axial push element axially movable relative to the base element in the direction of the second spindle shaft to push the second spindle shaft axially towards the first spindle shaft; and
at least one actuating element, the actuating element being movable relative to the base element to axially move the axial push element relative to the base element.

18. A machine tool, comprising:
a tool head of claim 1; and
at least one workpiece spindle for driving a workpiece to rotate about a workpiece axis.

19. The tool head of claim 1,
wherein the tool-side first spindle bearing defines a first bearing plane perpendicular to the tool spindle axis,
wherein the tool-side second spindle bearing defines a second bearing plane perpendicular to the tool spindle axis,
wherein the first balancing device defines a first balancing plane perpendicular to the tool spindle axis,
the second balancing device defining a second balancing plane perpendicular to the tool spindle axis, and
wherein the first balancing plane is arranged between the first bearing plane and the second balancing plane or the second balancing plane is arranged between the second bearing plane and the first balancing plane.

20. The tool head of claim 11, wherein the control device is configured to perform automatic two-plane balancing.

21. The tool head of claim 15, wherein the tool is a grinding tool for gear grinding.
